(19) United States
(12) Patent Application Publication
(10) Pub. No.: US 2003/0142929 A1
(43) Pub. Date: Jul. 31, 2003

(54) Flex board interface to an optical module

(76) Inventors: Meir Bartur, Los Angeles, CA (US); Sean Zargari, Los Angeles, CA (US)

Correspondence Address: David L. Henty, Myers, Dawes & Andras LLP, Suite 1150, 19900 MacArthur Blvd., Irvine, CA, 92612, US

(21) Appl. No.: 10/349,257

(22) Filed: Jan. 22, 2003

Related U.S. Application Data
(60) Provisional application No. 60/350,580, filed on Jan. 22, 2002.
(60) Provisional application No. 60/353,150, filed on Feb. 1, 2002.

(51) Int. Cl. G02B 6/42

(52) U.S. Cl. 385/92

(57) ABSTRACT

An optical module comprising a flexible circuit board adapted for mounting the optical module onto a printed circuit board (PCB). The flexible circuit board includes circuitry to effectively match impedances between the optical module components and the electrical circuitry on the PCB mounted close to the active component. The flexible circuit board may also include circuit components to filter the power supply voltage and provide a ground layer to reduce ground loop currents. In separate embodiments, the flex board can be mounted to the PCB at different relative vertical locations. Also disclosed are multiple circuits appropriate for different optical modules that include: laser diodes, avalanche photodiodes, avalanche photodiodes with a transimpedance amplifier, PIN photodiodes, and other optical components in various combinations.

### RELATED APPLICATION INFORMATION

The present application is related to U.S. Provisional Patent Application serial No. 60/350,580, filed on Jan. 22, 2002 and to U.S. Provisional Application No. 60/353,150 filed Feb. 1, 2002, which are incorporated herein by reference and to which priority is claimed pursuant to 35 USC 119 (e).

### BACKGROUND OF THE INVENTION

1. Field of the Invention

This invention relates generally to fiber optical modules for converting an electrical signal to an optical signal and for converting an optical signal to an electrical signal and to methods of interfacing an optical module to a circuit on a printed circuit board.

2. Description of the Related Art

Optical modules are used in fiber optic network applications and other applications where optical fibers are coupled to optical components. An optical module may contain one or more active optical components as well as passive optical components, such as beam splitters, filters and lenses, in any of a variety of combinations. The active optical components are used to convert an electrical signal to an optical signal for transmission over the fiber or for converting an optical signal to an electrical signal in receiving an optical signal from the fiber. A laser diode is an example of an active optical component used for transmitting an optical signal. The laser diode emits a modulated light signal based on an input electrical signal which can be used to transmit information over a fiber. Conversely, a photodiode is an active optical component that will detect optical power received from a fiber and convert it to electrical signals which are provided to receive circuitry. The electrical transmit and/or receive circuitry are mounted into either a single printed circuit board (PCB) or on separate PCBs.

Optical modules in the prior art typically use metal pins to electrically connect the optical components to the external electronics circuits. FIG. 1 illustrates an optical module 10 with the metal pins 20 extending from conventional Transistor Outline (TO) packages (or cans) housing active optical components. The pins are bent, cut to a particular length, and soldered to a printed circuit board 30 to allow electrical contact. The existing method is dictated in large part by the standardized TO package which allows optical component manufacturers to provide standardized parts for a variety of applications. The pins thus allow assembly of the components to a variety of different PCB designs.

Although the conventional approach does provide a uniform method for attaching modules to PCBs of various types it has several disadvantages. One disadvantage of significance at higher frequencies is the difficulty to control the high frequency impedance of the connection between the module and the PCB circuitry. This is due to inherent inductance associated with each single lead, packaging capacitance and the variability in pin length between the optical module and the printed circuit board contact. For example, when cutting and installing the pins of a laser diode module, unless there is a special tooling made for bending and cutting to a specific length of the pins, the pin lengths which are part of the transmission line from the laser driver to the laser chip, may be too short or too long. Therefore, there is inherently impedance mismatching between the optical module component, e.g., laser diode, and the circuitry on the PCB. Impedance mismatching will reduce performance and frequency response of the output optical signal. Furthermore this difference in length of the pins for a optical component will require custom matching circuitry for each optical component which will be labor intensive and expensive for volume manufacturing. The only alternative is relatively time consuming and expensive impedance matching undertaken on an application specific basis using special tooling and measurements as noted above. Another problem is that some metal pins may make physical contact with each other causing shorting. Also, bending is labor intensive and inherently suffer from poor yield due to glass to metal seal cracking in the TO can following stress on the lead during bending.

In light of the above, a need exists for improved interfacing between an optical module and circuitry on a PCB. Furthermore a need exists for an approach that can be used for a variety of optical modules and PCB layouts. In addition it is important that such an improved approach be relatively inexpensive to implement.

### SUMMARY OF THE INVENTION

In a first aspect, the present invention provides an optical module that contains at least one active optical component having plural electrical contacts that are used to receive power and to transmit or receive electrical signals. A flexible circuit board is electrically coupled to the electrical contacts and has interface contacts for interfacing the active optical component to circuitry external to the module. For example, such external circuitry may comprise transmit or receive circuitry on a printed circuit board (PCB).

The optical module, in an exemplary embodiment, contains a housing and the active optical component is configured in a package mounted inside the housing. The electrical contacts may be in the form of a plurality of pins extending outward from the package and the flexible circuit board includes a plurality of apertures extending through the flexible board to fit over the plurality of pins extending outward from the package. The circuitry contained within the flexible circuit board is, in one aspect, designed for impedance matching of the optical component and the external circuitry.

The flexible circuit board circuitry in an exemplary embodiment preferably includes a power supply circuit and filter circuitry provided to filter voltage supplied the optical component and controlled impedance lines in the form of microstrip or co-planar waveguides or striplines or any other type of transmission lines. A ground connection is also provided and the filter circuitry includes one or more capacitors coupled between the power supply circuit and the ground connection. In a particular embodiment, the flexible circuit board is a multi-layer flexible structure that includes a conductive trace layer and a conductive ground plane layer separated by an insulating layer. Additionally, the flexible board circuitry can be selectively configured for various combinations of different optical components and may include additional impedance matching and filter circuit elements. In exemplary embodiments, the optical components may comprise a laser diode, a laser diode with a back facet monitoring photodiode, a receive photodiode and a transimpedance amplifier, an avalanche photodiode, an avalanche photodiode with a transimpedance amplifier, a PIN photodiode, and a PIN photodiode with a transimpedance amplifier.

In a second aspect, the present invention provides a method of interfacing an optical module and a circuit on a printed circuit board (PCB), the optical module having a plurality of pins extending outward from the module. The method comprises providing a flexible board having circuitry to electrically connect the optical module to the circuit on the PCB. The method further comprises positioning the flexible board over the plurality of pins extending outward from the module, wherein the pins fit through a plurality of apertures in the flexible board at one location. Next, the excess length of the plurality of pins are cut and soldered to electrically connect the optical module to the flexible board. Thereafter, interface contacts are soldered at a second location on the flexible board to the PCB to electrically connect the flexible board to the PCB. The optical module, flexible board and the circuit on the PCB will have electrical impedances and the method may include providing circuitry on the flexible board to substantially match the impedances of the optical module to the circuit on the PCB.

In a third aspect, the present invention provides a fiber optic assembly that includes an optical module comprising one or more active optical components coupled to an optical fiber. The fiber optic assembly further comprises a printed circuit board comprising electrical transmitter and/or electrical receiver circuitry and one or more flexible circuit boards electrically connecting the module to the printed circuit board. In alternative embodiments, the flexible board connects the optical module on top of the PCB, or alternatively, at a different vertical position than the PCB.

Further objects, advantages and features of the present invention will become apparent to those skilled in the art from the following detailed description, when read in conjunction with the accompanying drawings.

### BRIEF DESCRIPTION OF THE DRAWINGS

FIG. 1 is a perspective view of an optical module in the prior art showing metal pins (leads) extending outward from the sides before connection to a printed circuit board (PCB);

FIGS. 2a and 2d are perspective views of an optical module before and after mounting to flexible circuit boards shown in FIGS. 2b and 2c, in accordance with the present invention;

FIGS. 3a and 3b are side views of an optical module of the present invention mounted to a PCB at different relative positions;

FIGS. 4a and 4b are schematic top view drawings of flexible circuit boards and circuitry embodied by the present invention, configured for a laser diode optical module with a common pin between the laser diode and the back facet monitor diode; 4a is for down connection and 4b for up connection.

FIG. 4c is a schematic sketch of the bottom of the laser TO can onto which the bottom of the flexible board in FIG. 4a or 4b connects;

FIG. 4d is a circuit diagram of the flexible circuit board of FIG. 4a;

FIGS. 5a and 5b are schematic top view drawings of flexible circuit boards and circuitry embodied by the present invention, configured for a laser diode optical module with separate laser and back facet monitor pins; 5a is for down connection and 5b for up connection.

FIG. 5c is a schematic sketch of the bottom of the laser TO can onto which the bottom of the flexible board in FIG. 5a or 5b connects;

FIG. 5d is a circuit diagram of the flexible circuit board of FIG. 5a;

FIG. 6a is a schematic top view drawing of a flexible circuit board of the present invention for a laser diode module used inside a small form-factor plugable (SFP) optical transceiver module.

FIG. 6b is a schematic sketch of the bottom of the laser TO can onto which the bottom of the flexible board in FIG. 6a connects;

FIG. 6c is a circuit diagram of the flexible circuit board of FIG. 6a;

FIG. 7a is a schematic top view drawing of a flexible circuit board of the present invention for a PIN photodiode optical module;

FIG. 7b is a schematic sketch of the bottom of the PIN detector TO can onto which the bottom of the flexible board in FIG. 7a connects;

FIG. 7c is a circuit diagram of the flexible circuit board of FIG. 7a;

FIG. 8a is a schematic top view drawing of a flexible circuit board of the present invention for an avalanche photo diode-transimpedance amplifier (APD-TIA);

FIG. 8b is a schematic sketch of the bottom of the APD-TIA TO can onto which the bottom of the flexible board in FIG. 8a connects;

FIG. 8c is a circuit diagram of the flexible circuit board of FIG. 8a;

FIG. 9a is a schematic top view drawing of a flexible circuit board of the present invention for an analog PIN-RF amplifier;

FIG. 9b is a schematic sketch of the bottom of the PIN-RF amplifier PC board onto which the bottom of the flexible board in FIG. 9a connects;

FIG. 9c is a circuit diagram of the flexible circuit board of FIG. 9a;

FIG. 10a is a schematic top view drawing of a flexible circuit board of the present invention, for a PIN diode optical module with a transimpedance amplifier (PIN-TIA);

FIG. 10b is a schematic sketch of the bottom of the PIN-TIA TO can onto which the bottom of the flexible board in FIG. 10a connects;

FIG. 10c is a circuit diagram of the flexible circuit board of FIG. 10a;

FIG. 11a is a schematic top view drawing of a flexible circuit board of the present invention for a PIN photodiode-transimpedance amplifier (PIN-TIA) used inside a small form-factor plugable (SFP) optical transceiver module;

FIG. 11b is a schematic sketch of the bottom of the PIN-TIA TO can onto which the bottom of the flexible board in FIG. 11a connects;

FIG. 11c is a circuit diagram of the flexible circuit board of FIG. 11a;

FIG. 12a is a schematic top view drawing of a flexible circuit board of the present invention, for another PIN photodiode optical module with a transimpedance amplifier (PIN-TIA);

FIG. 12b is a schematic sketch of the bottom of the PIN-TIA TO can onto which the bottom of the flexible board in FIG. 12a connects;

FIG. 12c is a circuit diagram of the flexible circuit board of FIG. 12a;

FIG. 13a is a schematic top view drawing of another flexible circuit board of the present invention, for PIN-TIA optical module used inside a SFP optical transceiver module;

FIG. 13b is a schematic sketch of the bottom of the PIN-TIA TO can onto which the bottom of the flexible board in FIG. 13a connects;

FIG. 13c is a circuit diagram of the flexible circuit board of FIG. 13a.

### DETAILED DESCRIPTION OF THE INVENTION

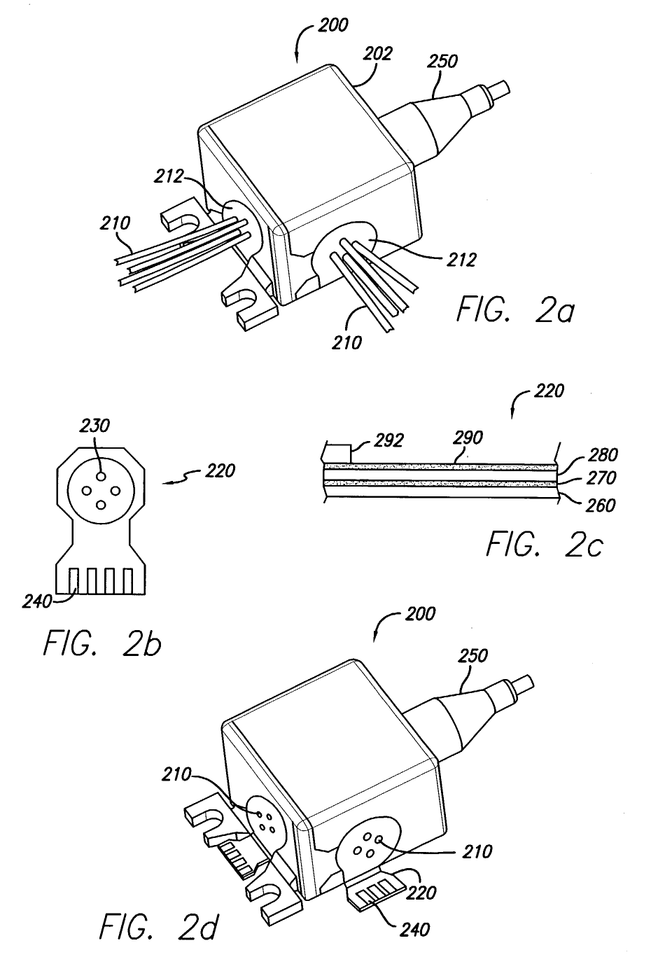

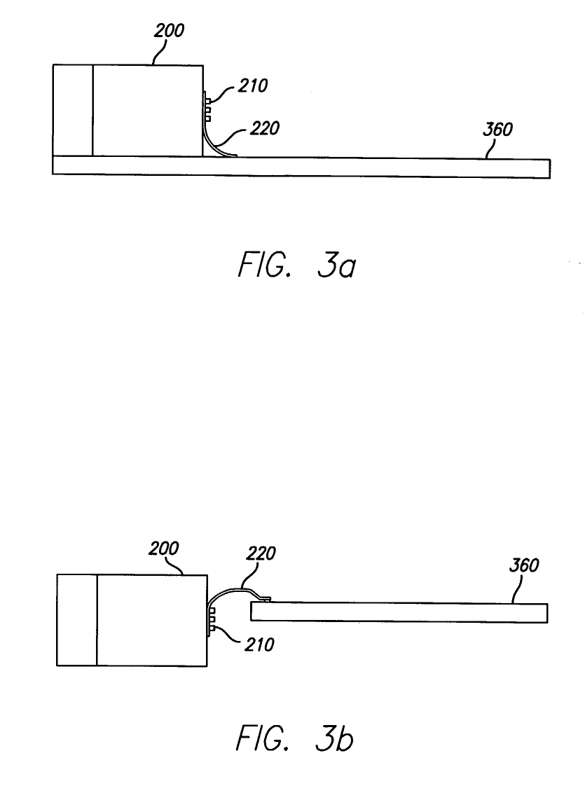

Referring to FIGS. 2a, 2b, 2c and 2d and FIGS. 3a and 3b an optical module and optical module/PCB fiber optic assembly in accordance with the present invention are illustrated. More specifically, in FIGS. 2a and 2c an optical module 200 is illustrated before and after assembly with a flex board electrical interface shown in FIGS. 2b and 2c. In FIGS. 3a and 3b the optical module 200 is illustrated connected in two different configurations to a PCB containing electrical circuitry.

Initially referring to FIG. 2a, optical module 200 is shown before assembly with flex boards 220 shown in FIGS. 2b and 2c. The optical module 200 comprises one or more active optical components as well as optional passive optical components, such as beam splitters, filters and lenses, in any of a variety of combinations. These optical components are configured to optically couple modulated light signals to and from optical fiber 250. Although a single fiber is illustrated more than one fiber may also be coupled to the module, depending on the application. Also, the module may include an optical connector such that the external fiber can be plugged in and out. The active optical components may include transmit laser diodes, back facet monitoring photodiodes and receiver photodiodes. Other examples of optical and electrical components which may be in optical module 200 include, without limitation: APD (avalanche photodiodes), APD-TIA (avalanche photodiodes with a transimpedance amplifier (TIA)), PIN photodiodes, and PIN-TIA (PIN photodiodes with a transimpedance amplifier). Specific embodiments of optical modules and optical components are described in U.S. patent application Ser. No. 09/836,500 entitled OPTICAL NETWORKING UNIT EMPLOYING OPTIMIZED OPTICAL PACKAGING to Meir Bartur et al., filed Apr. 17, 2001, the disclosure of which is incorporated herein by reference in its entirety. In addition, published PCT application of the same title, international application number PCT/US01/27436, discloses similar subject matter and is incorporated herein by reference in its entirety. In addition a specific embodiment of a three active optical component module is shown in U.S. Provisional Application Serial No. 60/353,150 filed Feb. 1, 2002, which is incorporated herein by reference in its entirety. The optical module 200 may preferably comprise a housing 202 which contains the one or more active optical components. The active optical components to be coupled to the flex boards may be contained in conventional packages 212 mounted within the module housing 202. More specifically as shown in FIG. 2a, the optical module 200 has metal pins 210 extending from each transistor outline (TO) package 212. Although a TO is a conventional cylindrical package for active optical components, other packages may be employed having electrical connection wires, pins or other contacts extending from the module. Also, a separate housing and optical component package is not necessary in all applications and the optical module may simply comprise the optical component and a suitable mounting or support structure, coupled to the flex board. The number of flex boards 220 will depend on the number of electrical connections for the particular application and the illustrated example of two flex boards and two TO packages is provided purely as an example for a bi-directional optical module application. A single flex board may be employed where a single active optical device such as a transmit laser diode or receive photodiode is coupled to an optical fiber. Additional flex boards may be provided where additional active optical devices or electrical devices are incorporated in the optical module; for example, optical modules employing three active optical devices are illustrated in the above noted U.S. patent application Ser. No. 09/836,500 and international application number PCT/US01/27436, and three flex boards would be employed for such embodiments of the present invention. Flex boards circuits may be combined to form complex shapes, connecting to more than one device.

As shown in FIGS. 2b and 2c the flex boards 220 have a general shape including a base portion adapted to fit over the TO can 212 (or other optical device package) with corresponding apertures 230 for the TO can pins 210. The flex circuit boards 220 preferably have a multi-layer structure as shown in FIG. 2c. In particular, the flex circuit boards 220 preferably have a lower flexible insulating layer 260 on which is formed a ground plane layer 270 of a conductive metal. The ground plane layer reduces the ground loop currents caused by a lack of a good low impedance connection to the PCB ground plane and can reduce signal noise and reduce cross talk and emission that can radiatively couple energy to the circuitry and impair performance. Furthermore to design a controlled impedance line, e.g. 50 ohms characteristic impedance, it requires a ground plane on the bottom layer with fixed line width on top layer to achieve fixed impedance line for good matching to the PCB For example the output of the PIN-TIA receiver 220 is typically 50 ohms and the external mating PCB electronics input impedance is also 50 ohms then the transmission line connecting the two must be designed for 50 ohms.

The characteristic impedance of the line depends on the ground plane, insulating layer 280 with a particular dielectric constant, width of the line and its spacing between the top and bottom layer. The flexible insulating layer 280 separates the ground plane layer from the trace layer 290 on which the conductive signal and power supply traces are formed. For complex applications multi-layer flex can be deployed as explained below. Discrete circuit components 292 may also be mounted on this upper layer. Such discrete circuit components may include capacitors and resistors which are coupled to the traces and/or ground plane to provide specific circuit elements such as filters or to set impedance values, as described in more detail below with respect to several specific embodiments. These discrete circuit components may alternatively be configured on a separate layer from the traces. Also, these discrete circuit components and in particular the capacitors may couple one or more traces to the ground plane through vias (not shown) between the layers. Also, additional layers may be provided; for example, one or more separate power supply layers may be provided to isolate power supply voltages and reduce possibility of shorting, and such additional power supply layer(s) would be separated by insulating layers from the other conductive layers.

Referring to FIG. 2d, each flexible circuit board 220 is positioned over the corresponding TO can of the module 200 with the pins 210 extending through apertures 230 in the flexible board 220 and the base portion of the flexible circuit board conforming to the outside surface of the active optical component package (e.g., TO can 212 outer surface). The flexible board 220 is then soldered to the metal pins 210 on the rear of the TO header. The pins 210 are then cut so they are substantially flush with the outside surface of the active optical component package (e.g., TO can 212 outer surface). FIG. 2d illustrates the resulting configuration for two flex boards and two TO packages. Circuit traces on the flexible board connect the pins of the optical module 200 to plural electrical interface contacts 240, for example, solderable pads at the edge of the flexible circuit board 220 module. These pads 240 are then soldered to a printed circuit board (PCB) 360 housing the electrical transmitter or receiver circuitry (see FIGS. 3a and 3b discussed below).

FIGS. 3a and 3b are side views of the PCB and optical module assembly of the present invention. The base portion of the flexible circuit board conforms to the active optical component package as discussed above and the flexed portion of the flexible circuit board provides connection to the PCB. The two views show the ability of the flexible circuit board to be mounted to the PCB at different relative vertical positions to the rigid PCB 360. In particular, FIG. 3a shows a down connection to a lower PCB location and FIG. 3b shows an up connection to a higher PCB location. These connections may be combined, for example, where two different optical components in a module are connected to two PCB's, one lower and one upper. Also, a flexible circuit board 220 of different lengths may be employed by adjusting the position or orientation of the module. It may be desirable to minimize the length of the flexible circuit board 220 in order to improve frequency bandwidth and the overall performance of the optical module 200. The flex board also acts as stress relief during assembly and during operation. Temperature variation can generate stress onto the leads and PCB that may result in a poor contact or reliability issues. The flexible nature of the flex board interface to the PCB relieves this temperature induced stress. The PCB 360 contains electrical circuitry comprising transmitter (Tx) and/or receiver (Rx) circuitry. Examples of such Tx and Rx circuitry are described in U.S. patent application Ser. No. 09/907,232 filed Jul. 17, 2001 for FIBER OPTIC TRANSCEIVER EMPLOYING ANALOG DUAL LOOP COMPENSATION to Meir Bartur et al., U.S. patent application Ser. No. 09/907,056 filed Jul. 17, 2001 for FIBER OPTIC TRANSCEIVER EMPLOYING DIGITAL DUAL LOOP COMPENSATION to Jim Stephenson, U.S. patent application Ser. No. 09/907,137 filed Jul. 17, 2001 for FIBER OPTIC TRANSCEIVER EMPLOYING FRONT END LEVEL CONTROL to Meir Bartur et al., and U.S. patent application Ser. No. 09/907,057 filed Jul. 17, 2001 for FIBER OPTIC TRANSCEIVER EMPLOYING CLOCK AND DATA PHASE ALIGNER to Meir Bartur et al., the disclosures of which are incorporated herein by reference in their entirety.

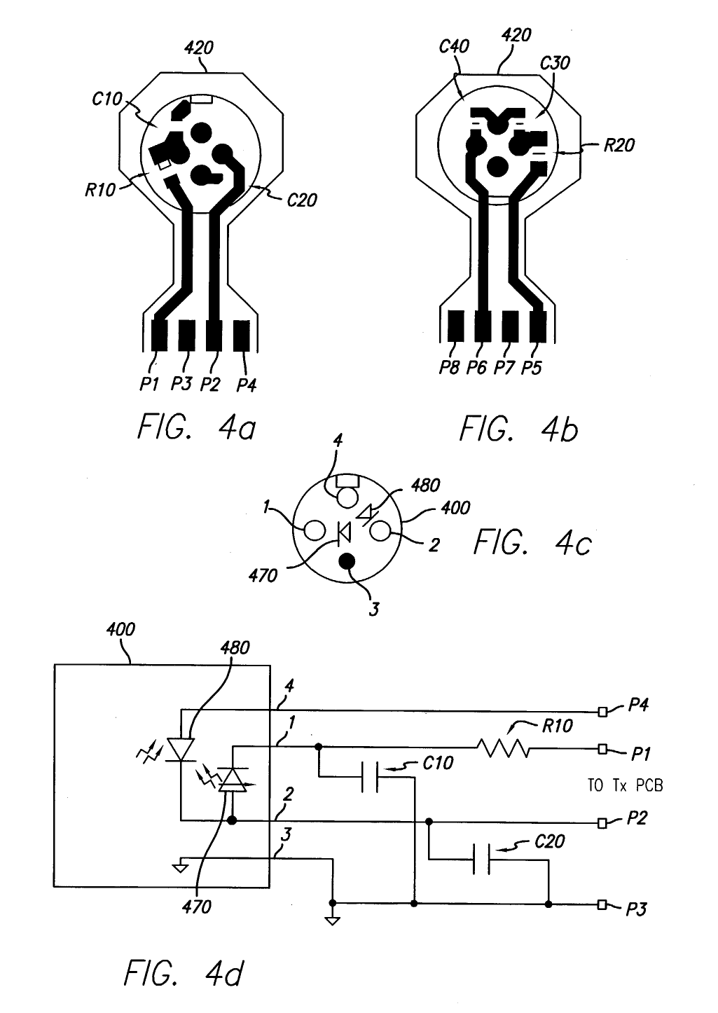

Now referring to FIGS. 4 to 13 several specific embodiments of the present invention are illustrated showing specific flex board circuits adapted for specific optical device applications. In general the problem of connection to an active optical component is impedance mismatch. For example, laser diode typically have 5-10 ohm impedance, which is considered very low. When a laser is connected to a drive circuitry the serial inductance of the lead wires affect the frequency response of the Laser. The customary method of adding a series resistance to the drive circuitry suffers from the same problem if the additional series resistor is on the PCB. The flex board enables placement of the matching circuitry very close to the active device hence very low lead impedance. Preferably matching circuitry components are configured on the base portion of the flexible circuit which is configured over top of the optical component package (eg. TO can header). In particular, preferably matching circuitry is placed directly at the connection points, i.e. as close as possible to the pin while allowing the pin to extend through the flexible circuit and make a solder or other connection to the flexible board circuitry.

First referring to FIGS. 4a through 4d, schematic representations of flexible circuit boards 420 and circuitry embodied by the present invention are shown for a laser diode optical module 400 with a common pin 2 between the laser diode 470 and the back facet monitor photodiode 480. As is known in the art, a back facet monitor photodiode 480 is a photodiode that detects light emission from the rear facet of the semiconductor of the laser diode 470 and produces photocurrent that is used to provide feedback control of the laser diode drive current by the external Tx circuitry. More specifically, FIG. 4a illustrates a flexible board 420 and associated circuitry traces and components corresponding to the circuit in FIG. 4d connecting to laser diode optical module 400 shown in FIGS. 4c and 4d. The circuit couples pins 1, 2, 3, 4 of the module, illustrated as a TO can, to pads P1, P2, P3 and P4 which are soldered to the matching contacts on the PCB. FIG. 4b is an alternate layout of flexible circuit board 420, designed to couple to PCB board in the other direction, i.e. an up connection as in FIG. 3b, that may be used for laser diode optical module 400.

Referring to FIG. 4d, the illustrated flexible board 420 layout and discrete components allows accurate impedance matching of the optical module 400 to the electronics circuit (Tx) by choice of circuit length and use of one or more resistors (one resistor R10 being shown). With accurate matching of impedances, higher bandwidths can be achieved thus improving system performance. Also, the matching electronic discrete components can be placed on the flexible board 420 very close to optical components (470, 480) to match the optics to the electronics, as shown in FIGS. 4a and 4b. For example, a laser driver with 25 ohm output impedance on the PCB and a laser with a 5 ohm impedance require a 20 ohm resistor placed very close to the modulation input of the laser to match impedance of the laser to the laser driver. Resistor R10 may be placed very close-to the pin as shown in FIG. 4a meeting such a stringent requirement. The traces of the flex board can be designed to act as microstrip lines or co-planar wave-guide (when the dielectric and thickness parameters for the insulating layer 280 are known). Wave-guide enables selection of the characteristic impedance for optimized broadband matching. The design of microstrip or co-planar wave-guides and the resultant charachteristic impedance is well known. As another objective, high frequency power supply filtering can be accomplished by placing filters on the flexible board 420 as close as possible to the laser 470 and/or photodiode 480 pins requiring power supply voltage and hence improving performance and reducing system noise. For example a filter capacitor C20 and C10 to ground on the flexible board can be positioned very close to the laser anode and/or cathode pins as shown in FIG. 4a, and can improve the high frequency response of the output optical signal and prevent noise from degrading laser performance. Use of a flexible circuit board 420 with a layer of ground plane (P3) is also valuable in reducing EMI and the ground loop currents caused by a lack of a good low impedance connection from the case pin 3 of the optical module to the ground plane on the rigid printed circuit board and its circuits (e.g., provides good ground contact from the laser driver circuit on the PCB to the laser 470). FIG. 4b shows an alternate layout of the impedance matching resistor R20 and filter capacitors C30 and C40 on flex circuit 420.

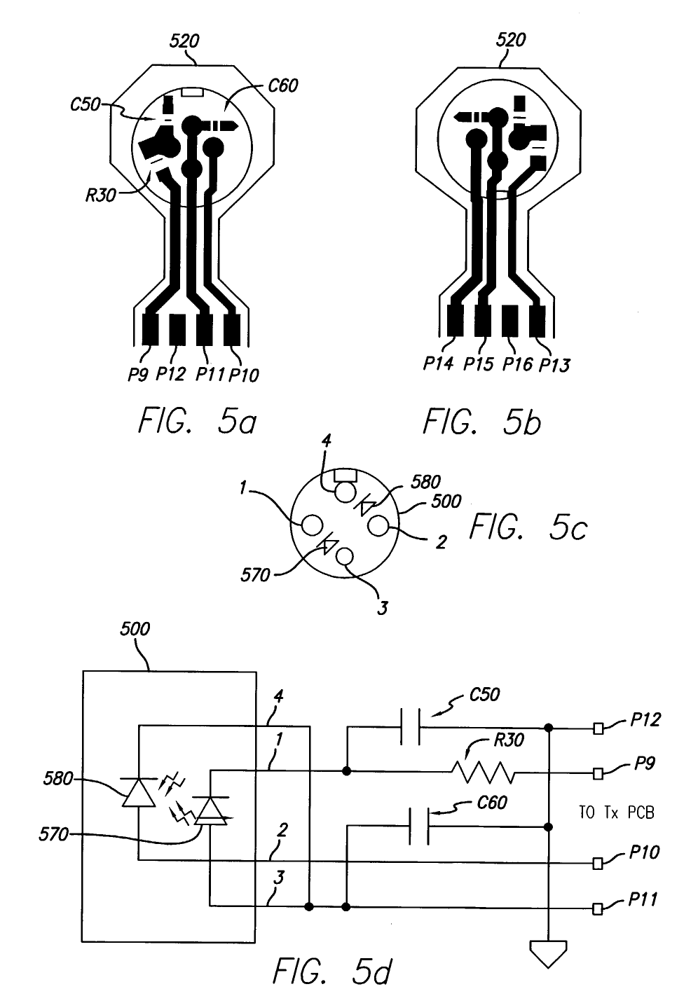

FIGS. 5a through 5d illustrate a flexible circuit board for a laser diode module 500 with separate laser 570 and back facet monitor 580 pins. FIG. 5a illustrates a flexible board 520 and associated traces and circuitry components that corresponds to the circuit of FIG. 5d connecting pads P9-P 11 to laser diode optical module 500 pins 1-4 shown in FIG. 5c. Impedance matching resistor R30 and filter capacitors C50 and C60 provide similar advantages as in the embodiment of FIGS. 4a-4d and as shown in FIG. 5a these elements may be configured very close to the corresponding module pins. Also, a ground plane may be coupled to pad P12 to provide the advantages described above. FIG. 5b is another version of flexible board 520 that may be used for laser diode optical module 500 coupled to a PCB in the up direction as shown in FIG. 3b.

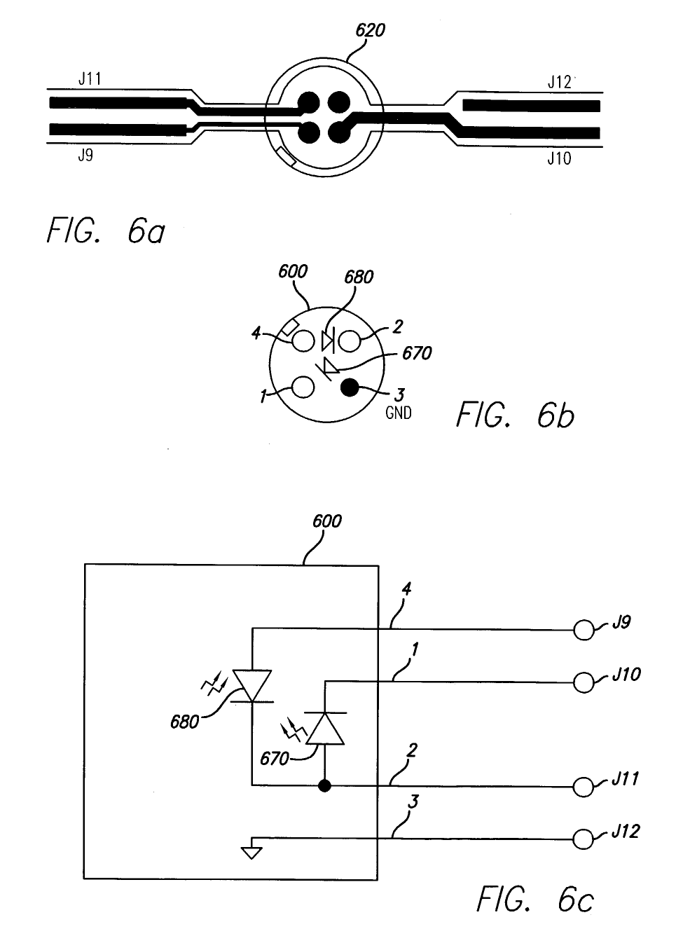

Referring to FIGS. 6a through 6c, a schematic drawing of a flexible circuit board 620 for a laser diode module 600 used inside a small form-factor plugable (SFP) optical transceiver module is shown. In the illustrated embodiment the flex circuit simply comprises traces coupled to pads J9 and J11 on one circuit strip and trace J10 and ground plane coupled to J12 on a second strip.

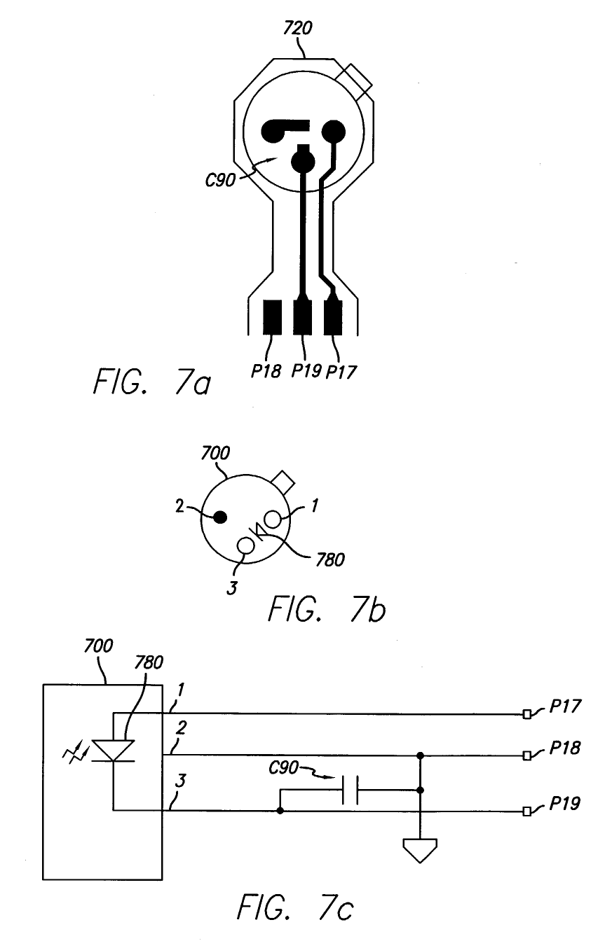

FIGS. 7a through 7c illustrate a flexible circuit board 720 for an optical receiver module 700 incorporating a PIN photodiode 780, in accordance with another embodiment of the present invention. The flexible circuit board 720 couples pins 1-3 on the module to PCB connection pads P17-P19. In this example, a filtering capacitor C90 to ground is physically located very close to the cathode of reverse biased PIN photodiode 780 to filter out the power supply noise. This filter close to the cathode of the PIN photodiode can improve the sensitivity of the optical receiver. The ground is preferably provided as a separate ground plane layer as described previously.

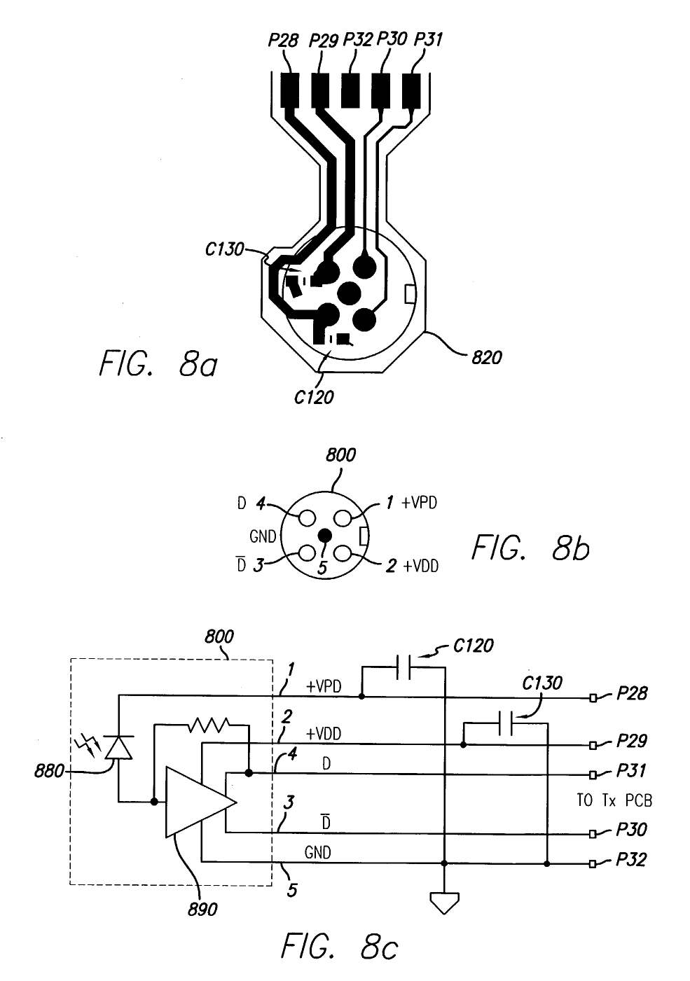

FIGS. 8a through 8c illustrate a flexible circuit board 820 in accordance with another embodiment of the present invention. The illustrated flexible circuit board is adapted to couple pins 1-5 of module 800 comprising an avalanche photodiode 880 and transimpedance amplifier 890 (APD-TIA) to pads P28-P32. Impedance matching is similarly achieved in this embodiment through choice of trace length. As an example, for an output impedance of the APD-TIA of 50 ohms, the flex board transmission lines are designed to have a 50 ohm impedance for improved performance. Also, filtering capacitors C120 and C130 are provided coupled to a ground plane close to power supply pins 1 and 2 to filter out power supply noise.

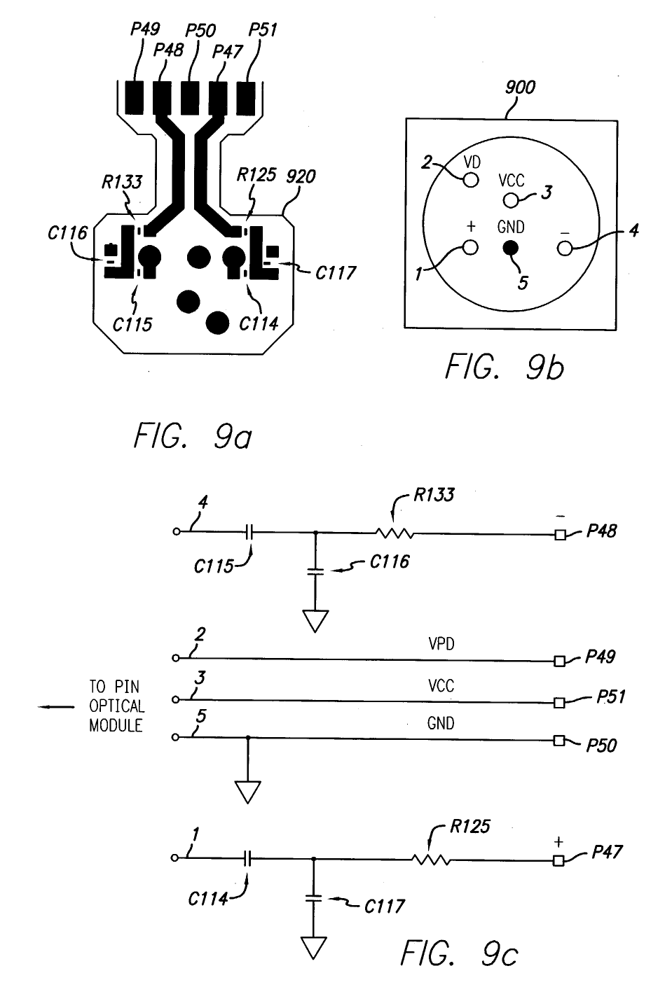

FIGS. 9a through 9c illustrate a flexible circuit board in accordance with another embodiment of the present invention. The illustrated flexible circuit board 920 of the present invention is adapted to couple pins 1-5 of module 900 comprising an analog PIN-amplifier to PCB connection pads P48-P51. The illustrated resistors and capacitors are provided for impedance matching and filtering as described in relation to previous embodiments.

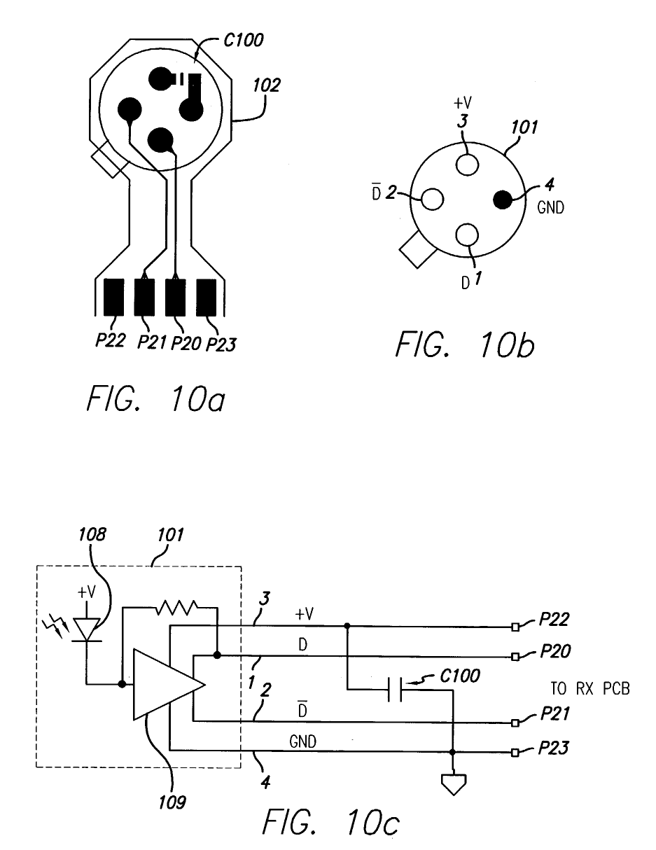

FIGS. 10a through 10c illustrate a flexible circuit board 102 in accordance with another embodiment of the present invention. The illustrated flexible circuit board of the present invention is adapted to couple pins 1-4 of optical module 101, comprising a PIN photodiode 108 with a transimpedance amplifier 109 (TIA), to PCB connection pads P20-P23. The circuit may be advantageously employed with high data rate receiver Rx circuitry. As an example, the PIN-TIA module 101 may be a 622 mega bit per second receiver module. Filter capacitor to ground C100, similar to other embodiments, is designed to reduce power supply noise and improve system performance.

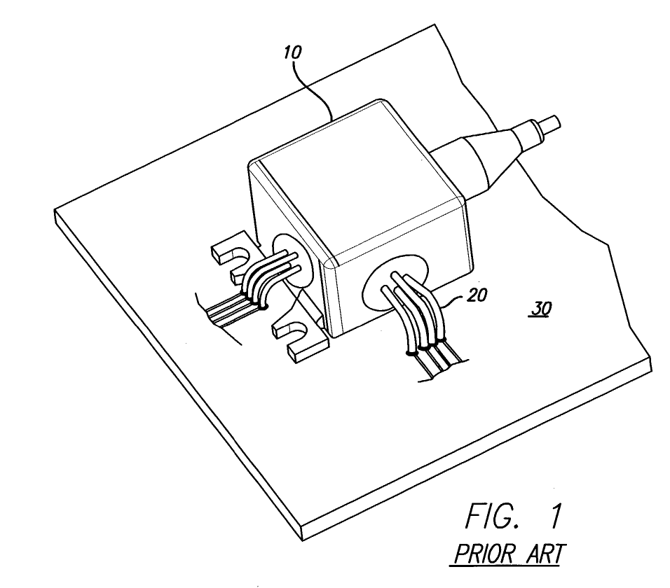

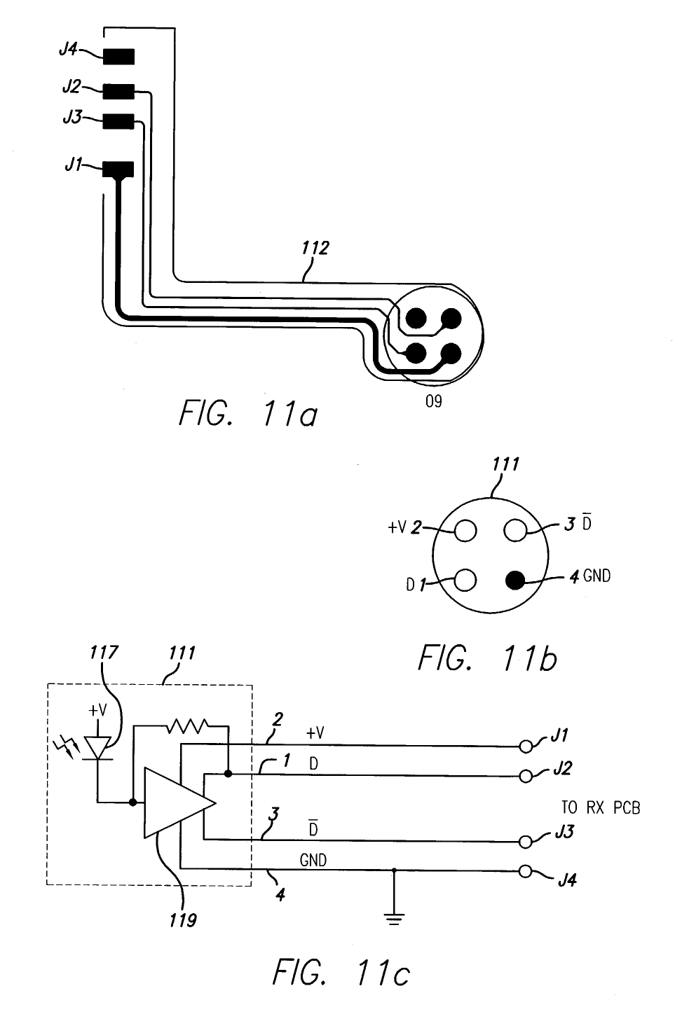

FIGS. 11a through 1c illustrate a flexible circuit board 112 in accordance with another embodiment of the present invention. The illustrated flexible circuit board of the present invention is adapted to couple pins 1-4 of optical module 111 comprising a PIN photodiode 117 and transimpedance amplifier 119 (PIN-TIA) used inside a small form-factor plugable (SFP) optical transceiver module to pads J1-J4. The circuit traces are of width and length chosen to provide the desired impedance match to module 111.

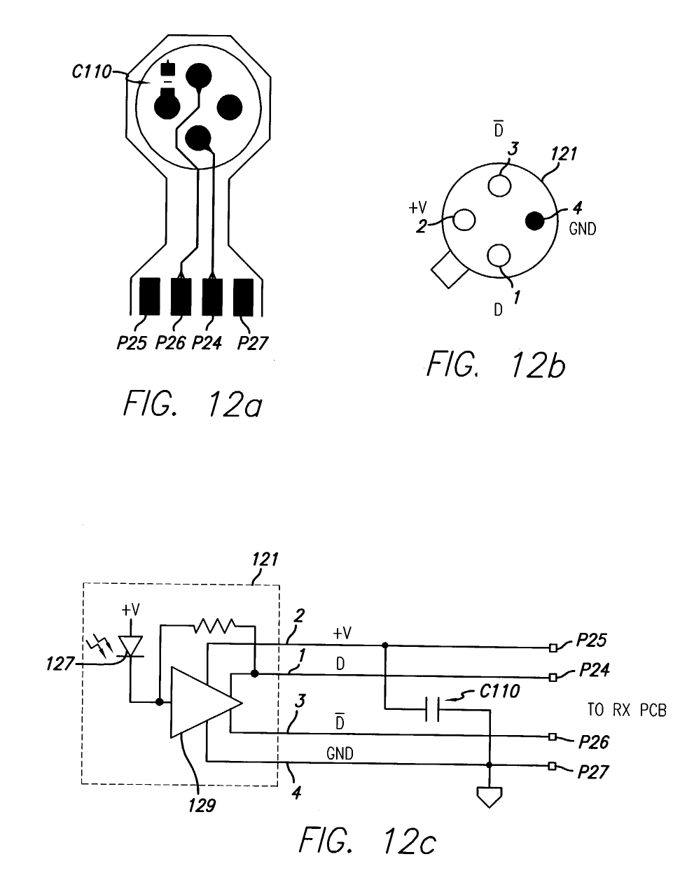

FIGS. 12a through 12c illustrate a flexible circuit board 122 in accordance with another embodiment of the present invention. The illustrated flexible circuit board of the present invention is adapted to couple pins 1-4 of optical module 121, comprising a PIN photodiode 127 with a transimpedance amplifier 129 (TIA), to pads P24-27. Filter capacitor C110 coupled to ground, similar to other embodiments, is designed to reduce power supply noise and improve system performance. The illustrated flexible circuit board of the present invention is adapted for high data rate applications. As an example, the PIN-TIA module 101 may be a 1.25 giga bit per second receiver module.

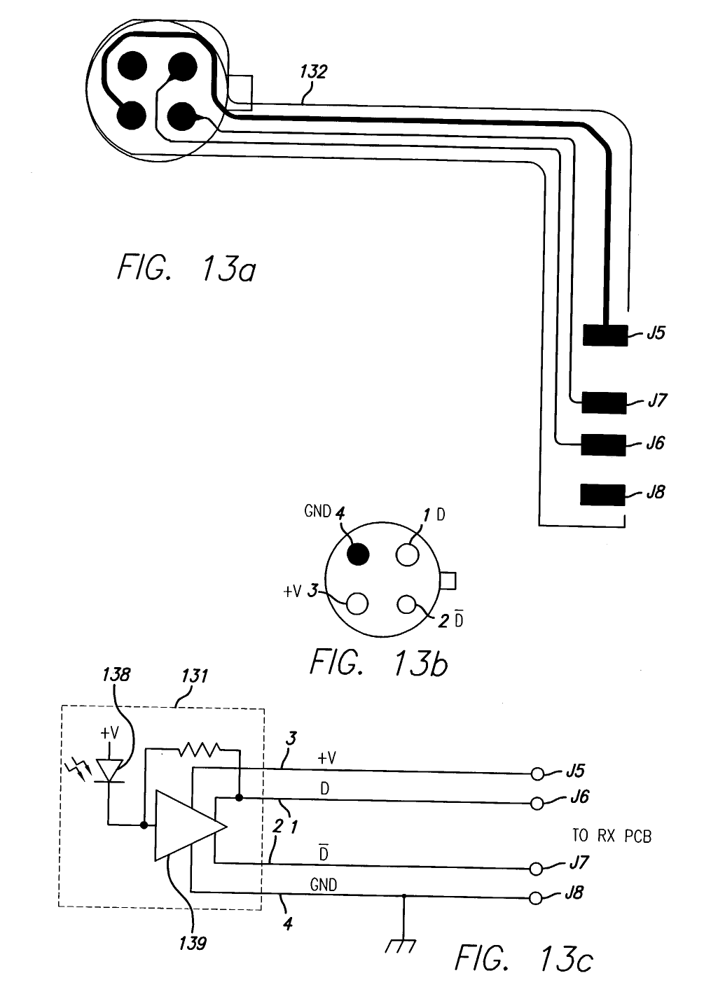

FIGS. 13a through 13c illustrate a flexible circuit board 132 in accordance with another embodiment of the present invention. The illustrated flexible circuit board of the present invention is adapted to couple pins 1-4 of optical module 131, comprising a PIN photodiode 138 and TIA 139, to pads J5-J8. The circuit traces are of length chosen to provide the desired impedance match to module 131. As an example, module 131 may comprise a 622 mega bit per second PIN photodiode and TIA optical module used inside a SFP optical transceiver module.

It should be appreciated that the foregoing description of the preferred embodiments of the present invention may be modified in a variety of different ways which should be apparent to those skilled in the art from the above teachings. Accordingly, the present invention should not be limited in any way to the illustrated embodiments as the present invention in its various aspects encompasses all such modifications and variations thereof which are too numerous to describe in specific detail herein. While the invention has been illustrated and described by means of specific embodiments, it is to be understood that numerous changes and modifications may be made therein without departing from the intent and scope of the invention as defined in the appended claims.

What is claimed is:

1. An optical module, comprising:
at least one active optical component configured in a package having an exterior surface and having plural electrical contacts substantially flush with said exterior surface to receive power and to transmit or receive electrical signals; and
a flexible circuit board having a base portion coupled to and conforming with said outside surface of said package and electrically coupled to said plural electrical contacts of said active optical component and having plural electrical interface contacts for interfacing said active optical component to circuitry external to the module.

2. An optical module according to claim 1, wherein the optical module further comprises a housing and said active optical component is configured in a package mounted in the housing, wherein the electrical contacts comprise a plurality of pins extending outward from the package and wherein the flexible circuit board comprises a plurality of apertures extending through the flexible board to fit over the plurality of pins extending outward from the package.

3. An optical module according to claim 1, wherein the flexible circuit board comprises circuitry for impedance matching of the optical component and the external circuitry.

4. An optical module according to claim 1, wherein said flexible circuit board comprises a power supply circuit and filter circuitry coupled to the power supply circuit for providing a power supply filter for the optical component.

5. An optical module according to claim 4, wherein said flexible circuit board further comprises a ground connection and wherein said filter circuitry comprises one or more capacitors coupled between the power supply circuit and said ground connection.

6. An optical module according to claim 3, wherein said circuitry for impedance matching comprises one or more resistors.

7. An optical module according to claim 1, wherein said plural electrical interface contacts comprise plural solderable pads to electrically connect the flexible board to the external circuitry.

8. An optical module according to claim 1, wherein said flexible circuit board comprises a multi-layer flexible structure including a conductive trace layer and a conductive ground plane layer separated by an insulating layer.

9. An optical module according to claim 8, wherein said flexible circuit board further comprises a capacitor electrically connected between a trace on the conductive trace layer and the conductive ground plane layer.

10. An optical module according to claim 1, further comprising one or more optical fibers optically connected to said optical component.

11. An optical module according to claim 1, wherein the optical component comprises a laser diode.

12. An optical module according to claim 11, wherein the optical component further comprises a back facet monitoring photodiode.

13. An optical module according to claim 11, wherein the flexible circuit board further comprises a ground layer, an impedance matching resistor coupled to the laser diode and a capacitor coupled between the ground layer and the laser diode.

14. An optical module according to claim 12, wherein the flexible circuit board further comprises a ground layer, an impedance matching resistor coupled to the laser diode, a first capacitor coupled between the ground layer and the laser diode and a second capacitor coupled between the ground layer and the back facet monitoring photodiode.

15. An optical module according to claim 1, wherein the optical component comprises a receive photodiode and a transimpedance amplifier and wherein the flexible circuit board comprises a ground layer, a first power supply connection for the photodiode, a second power supply connection for the transimpedance amplifier, a first capacitor coupled between the ground layer and the first power supply connection and a second capacitor coupled between the ground layer and the second power supply connection.

16. An optical module according to claim 1, wherein the optical module and interface contacts are configured to interface with a small form-factor (SFP) optical transceiver module.

17. An optical module according to claim 1, wherein the optical component comprises an avalanche photodiode.

18. An optical module according to claim 1, wherein the optical component comprises an avalanche photodiode with a transimpedance amplifier.

19. An optical module according to claim 1, wherein the optical component comprises a PIN photodiode.

20. An optical module according to claim 1, wherein the optical component comprises a PIN photodiode with a transimpedance amplifier.

21. An optical module according to claim 1, wherein the optical module includes an analog PIN amplifier.

22. A method of interfacing an optical module and a circuit on a printed circuit board (PCB), the optical module having a plurality of pins extending outward from the module, the method comprising:
providing a flexible board having circuitry to electrically connect the optical module to the circuit on the PCB;
positioning the flexible board over the plurality of pins extending outward from the module, wherein the pins fit through a plurality of apertures in the flexible board at one location;
cutting the excess length of the plurality of pins;
soldering the remaining pin portions to electrically connect the optical module to the flexible board; and
soldering interface contacts at a second location on the flexible board to the PCB to electrically connect the flexible board to the PCB.

23. The method of claim 22, wherein the optical module, flexible board and the circuit on the PCB have electrical impedances and further comprising the step of providing circuitry on the flexible board to provide an impedance to substantially match the impedances of the optical module to the circuit on the PCB.

24. A fiber optic assembly, comprising:
an optical module comprising one or more active optical components coupled to an optical fiber and configured in a package having an exterior surface;
a printed circuit board comprising electrical transmitter and/or electrical receiver circuitry; and
one or more flexible circuit boards having a base portion coupled to and conforming with said outside surface of said package and a flexed portion electrically connecting the module to the printed circuit board.

25. The fiber optic assembly according to claim 24, wherein the flexible board connects the optical module on top of the PCB.

26. The fiber optic assembly according to claim 24, wherein the flexible board connects the optical module at a different vertical position than the PCB.

27. An optical module, comprising:
at least one active optical component having plural electrical contacts to receive power and to transmit or receive electrical signals; and
a flexible circuit board electrically coupled to said plural electrical contacts of said active optical component and having plural electrical interface contacts for interfacing said active optical component to circuitry external to the module, wherein the flexible circuit board comprises circuitry for impedance matching of the optical component and the external circuitry and a co-planar wave-guide with controlled characteristic impedance.

28. An optical module according to claim 1, wherein the flexible circuit board comprises a discrete electrical component configured on said base portion adjacent an electrical contact of said active optical component to minimize the impedance of the connection to the contact.

29. An optical module according to claim 28, wherein said discrete electrical component is a capacitor.

30. An optical module according to claim 28, wherein said discrete electrical component is a resistor.
